(19) United States
(12) Patent Application Publication
(10) Pub. No.: US 2025/0193901 A1
(43) Pub. Date: Jun. 12, 2025

(54) Multi-Slot PDCCH Monitoring With Multiple Cells

(71) Applicant: Apple Inc., Cupertino, CA (US)

(72) Inventors: Oghenekome OTERI, San Diego, CA (US); Chunhai YAO, Beijing (CN); Chunxuan YE, San Diego, CA (US); Hong HE, San Jose, CA (US); Huaning NIU, San Jose, CA (US); Seyed Ali Akbar FAKOORIAN, San Diego, CA (US); Wei ZENG, Saratoga, CA (US)

(21) Appl. No.: 18/837,383

(22) PCT Filed: Feb. 11, 2022
(86) PCT No.: PCT/CN2022/076050

§ 371 Date: Aug. 9, 2024

(51) Int. Cl. H04W 72/231; H04L 5/00; H04W 72/51

(52) U.S. Cl. CPC H04W 72/231; H04L 5/001; H04W 72/51

(57) ABSTRACT

A user equipment (UE) is configured to transmit capability information to a base station corresponding to a release 17 (Rel-17) multi-slot physical downlink control channel (PDCCH) monitoring (MSM) capability and receive configuration information to perform MSM, wherein the UE is configured with a number of downlink cells that are greater than a reported number of downlink cells. A base station is configured to receive capability information from a user equipment (UE) corresponding to a release 17 (Rel-17) multi-slot physical downlink control channel (PDCCH) monitoring (MSM) capability and transmit configuration information to the UE related to MSM, wherein the UE is configured with a number of downlink cells that are greater than a reported number of downlink cells.

### TECHNICAL FIELD

The present disclosure generally relates to communication, and in particular, to multi-slot PDCCH monitoring with multiple cells.

### BACKGROUND

In a Fifth Generation (5G) New Radio (NR) network, for communication above 52.6 Giga hertz (GHz), the subcarrier spacing (SCS) may be increased to provide robustness to phase noise. For example, the SCS may be set to 120 kilo hertz (kHz), 480 kHz or 960 kHz. However, increasing the SCS may result in a reduction in the duration of the symbol which may place an unreasonable strain on user equipment (UE) processing resources during physical downlink control channel (PDCCH) monitoring. It has been identified that multi-slot PDCCH monitoring may be used to improve the efficiency of PDCCH monitoring for communication above 52.6 GHz.

### SUMMARY

Some exemplary embodiments are related to a processor of a user equipment (UE) configured to perform operations. The operations include transmitting capability information to a base station corresponding to a release 17 (Rel-17) multi-slot physical downlink control channel (PDCCH) monitoring (MSM) capability and receiving configuration information to perform MSM, wherein the UE is configured with a number of downlink cells that are greater than a reported number of downlink cells.

Other exemplary embodiments are related to a processor of a base station configured to perform operations. The operations include receiving capability information from a user equipment (UE) corresponding to a release 17 (Rel-17) multi-slot physical downlink control channel (PDCCH) monitoring (MSM) capability and transmitting configuration information to the UE related to MSM, wherein the UE is configured with a number of downlink cells that are greater than a reported number of downlink cells.

Still further exemplary embodiments are related to a user equipment (UE) having a transceiver configured to communicate with a network and a processor communicatively coupled to the transceiver and configured to perform operations. The operations include transmitting capability information to a base station corresponding to a release 17 (Rel-17) multi-slot physical downlink control channel (PDCCH) monitoring (MSM) capability and receiving configuration information to perform MSM, wherein the UE is configured with a number of downlink cells that are greater than a reported number of downlink cells.

Additional exemplary embodiments are related to a base station having a transceiver configured to communicate with a user equipment (UE) and a processor communicatively coupled to the transceiver and configured to perform operations. The operations include receiving capability information from the UE corresponding to a release 17 (Rel-17) multi-slot physical downlink control channel (PDCCH) monitoring (MSM) capability and transmitting configuration information to the UE related to MSM, wherein the UE is configured with a number of downlink cells that are greater than a reported number of downlink cells.

### BRIEF DESCRIPTION OF THE DRAWINGS

FIG. 1 shows an exemplary set of slot groups within a subframe according to various exemplary embodiments.

FIG. 2 shows an example arrangement of Group 1 and Group 2 slot groups according to various exemplary embodiments.

FIG. 3 shows an exemplary network arrangement according to various exemplary embodiments.

FIG. 4 shows an exemplary user equipment (UE) according to various exemplary embodiments.

FIG. 5 shows an exemplary base station according to various exemplary embodiments.

FIG. 6 shows a signaling diagram for reporting multi-slot physical downlink control channel (PDCCH) monitoring (MSM) capability information related to multiple cells according to various exemplary embodiments.

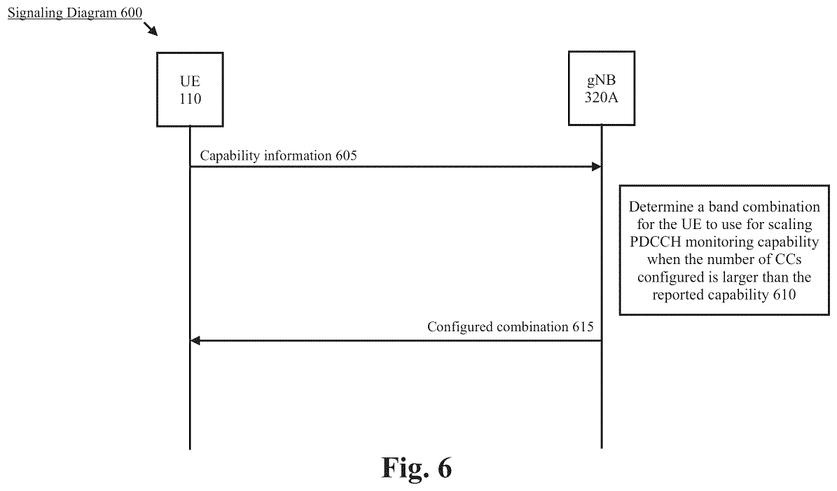

### DETAILED DESCRIPTION

The exemplary embodiments may be further understood with reference to the following description and the related appended drawings, wherein like elements are provided with the same reference numerals. The exemplary embodiments relate to enabling multi-slot physical downlink control channel (PDCCH) monitoring (MSM).

The exemplary embodiments are described with regard to a user equipment (UE). However, reference to a UE is merely provided for illustrative purposes. The exemplary embodiments may be utilized with any electronic component that may establish a connection to a network and is configured with the hardware, software, and/or firmware to exchange information and data with the network. Therefore, the UE as described herein is used to represent any electronic component.

In a Fifth Generation (5G) New Radio (NR) network, for communication above 52.6 Giga hertz (GHz), the subcarrier spacing (SCS) may be increased to provide robustness to phase noise. For example, the SCS may be set to 120 kilo hertz (kHz), 480 kHz or 960 KHz. However, increasing the SCS may result in a reduction in the duration of the symbol. From the perspective of the UE, the reduction in symbol duration may increase the number of operations that are to be performed by the UE for PDCCH monitoring which may place an unreasonable strain on UE processing resources.

It has been identified that it may be beneficial to utilize MSM for communication above 52.6 GHz. MSM may allow the UE to avoid the processing strain associated with other PDCCH monitoring approaches. However, while the exemplary techniques described herein may provide benefits to 5G NR communication above 52.6 GHz, the exemplary embodiments are not limited to this frequency range.

MSM may generally refer to a PDCCH monitoring approach that is based on slot groups that each comprise multiple consecutive slots. The UE may perform PDCCH monitoring within a search space (SS) during one or more slots of each slot group. To provide a general example, if a slot group comprises 4 consecutive slots, the UE may perform PDCCH monitoring during a SS within one or more slots of the 4 consecutive slots of the slot group. The UE may be configured with multiple slot groups that are each associated with the same or different frequency resources and/or overlap (fully or partially) in the time domain.

As will be described in more detail below, the exemplary embodiments introduce various techniques for enabling MSM with multiple cells. Each of the exemplary techniques may be used independently from one another, in conjunction with currently implemented MSM mechanisms, in conjunction with future implementations of MSM mechanisms or independently from other MSM mechanisms.

### Multi-Slot PDCCH Monitoring General Framework

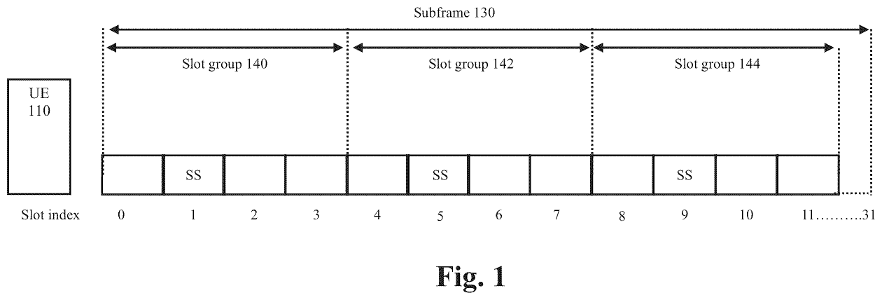

FIG. 1 shows an exemplary set of slot groups 140-144 within a subframe 130 according to various exemplary embodiments. This exemplary slot group arrangement is not intended to limit the exemplary embodiments in any way and is merely provided as a general overview of the relationship between a slot group and a subframe. A subframe may comprise slot or multiple slots (e.g., 2, 4, 5, 12, 16, etc.) and the exemplary embodiments are not limited to any particular number of slots or slot groups per subframe.

The UE 110 may be configured with a PDCCH that includes multiple subframes 130. In this example, the PDCCH may be configured with a SCS of 480 kHz and 32 slots per subframe. FIG. 1 shows a portion of a subframe 130 with 12 slots indexed 0-11. This portion of subframe 130 is arranged into 3 separate slot groups 140-144 and each slot group 140-144 comprises 4 slots. There are 32 slots per subframe in this example and thus, the remaining portion of subframe 130 that is not pictured in FIG. 1 may include 20 slots indexed 12-31. The slots indexed 12-31 may be arranged into 5 separate groups each comprising a slot group size of 4 slots. Therefore, while only 3 slot groups 140-144 are shown in FIG. 1, subframe 130 may include a total 8 slot groups with a slot group size of 4 slots across its 32 slots.

In this example, the UE 110 may be configured to perform PDCCH monitoring in 1 slot from each of the slot groups 140-144. Thus, in a first slot group 140 comprising slots indexed 0-3, the UE 110 may have a PDCCH SS during slot 1. During slots indexed 0, 2 and 3, the UE 110 has the opportunity to conserve power since the UE 110 is not configured to perform PDCCH monitoring during the other slots 0, 2, 3. In a second slot group 142 comprising slots indexed 4-7, the UE 110 may have a PDCCH SS during slot 5. During slots indexed 4, 6 and 7, the UE 110 has the opportunity to conserve power since the UE 110 is not configured to perform PDCCH monitoring during the other slots 4, 6, 7. In a third slot group 144 comprising slots indexed 8-11, the UE 110 may have a PDCCH SS during slot 9. During slots indexed 8, 10 and 11, the UE 110 has the opportunity to conserve power since the UE 110 is not configured to perform PDCCH monitoring during the other slots 8, 10, 11. The UE 110 may behave in the same manner on the other 5 slot groups referenced above in the remaining portion of subframe 130 that is not pictured in FIG. 1.

Slot groups may be consecutive to one another. Thus, in this example, slot group 140 comprises slots indexed 0-3, slot group 142 comprises slots indexed 4-7 and slot group 144 comprises slots indexed 8-11. The start of a first slot group in a subframe (e.g., slot group 140) may be aligned with a slot boundary (e.g., slot index 0 (not pictured)). The start of each slot group may be aligned with a slot boundary. In this example, there is no gap between the slot groups 140-144. FIG. 1 is not intended to limit the exemplary embodiments in any way and is merely provided as a general overview of the relationship between a slot group and a subframe. The exemplary embodiments may apply to any appropriate SCS, subframe duration, number of slots per subframe, number of slot groups, slot group size, etc.

A control resources set (CORESET) may be defined and based on the CORESET a SS may be defined. The UE 110 may perform PDCCH monitoring within the SS. The following examples provide a general overview of SSs within the slot group framework.

Throughout this description, reference is made to “Group 1” to identify a first set of consecutive slot groups and “Group 2” to identify a second set of consecutive slot groups. Those skilled in the art will understand that MSM Group 1 and Group 2 may be defined in third generation partnership program (3GPP) Specifications. The exemplary embodiments may utilize Group 1 and Group 2 in accordance with the manner in which these terms are defined in 3GPP documents and may be modified in accordance with the exemplary embodiments described herein.

The UE 110 may perform PDCCH monitoring within a SS configured within one or more slots of each slot group. For Group 1, the SSs may include a type 1 common search space (CSS) with dedicated radio resource control (RRC) configuration, a type 3 CSS, a UE specific SS and/or any other appropriate type of SS. For Group 2, the SSs may include a type 1 CSS without dedicated RRC configuration, a type 0 CSS, a type 0A CSS, a type 2 CSS and/or any other appropriate type of SS. Thus, “Group 1” and “Group 2” may encompass different types of SSs. Specific details regarding the arrangement of a Group 1 SS set and a Group 2 SS set are provided below.

The slot group size for Group 1 may be the same as or different than the slot group size for Group 2. In addition, Group 1 and Group 2 may each be associated with the same or different frequency resources and overlap (fully or partially) in the time domain. However, any reference to a particular Group 1 and/or Group 2 arrangement is not intended to limit the exemplary embodiments in any way and is merely provided as an example. The exemplary embodiments may apply to any appropriate SGS, subframe duration, number of slots per subframe, number of slot groups, slot group size, etc.

Group 1 may consist of (Xs) consecutive slots and a SS may be configured within (Ys) consecutive slots within the Xs slots of the slot group. The location of the Ys slots within the slot group may be maintained across different slot groups. To provide an example within the context of FIG. 1, Xs may be equal to 4 (e.g., slot index 0-3) and Ys may be equal to 1. The position of the SS (e.g., Ys) in slot group 140 is the same position of the SS in slot group 142 and 144.

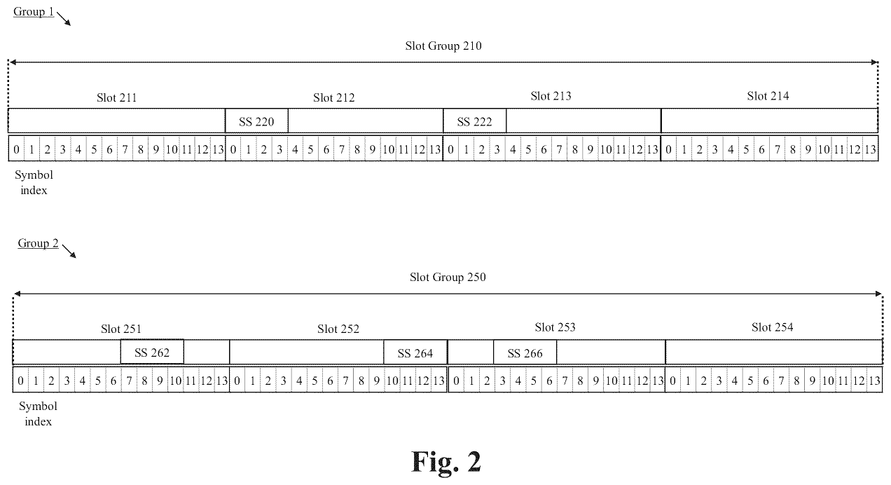

When Ys is equal to 1, the SS may be located anywhere within the Ys slot. However, the SS location may be subject to a gap-span limitation (W, Z) (e.g., release 15 (rel-15) gap-span, feature group (FG) 3-5b). For 480 kHz, the gap-span limitation (W, Z) may be (4, 3) or (7, 3) with a maximum of two monitoring spans per the Ys slot. For 960 KHz, the gap-span limitation (W, Z) may be (7, 3). An example arrangement of a Group 1 slot group is provided below with regard to FIG. 2.

When Ys is greater than 1, the SSs may be located in the first 3 symbols of each of the Ys slots. To provide an example within the context of FIG. 1, if each slot comprised symbols indexed 1-14, the SS in slot 1 of slot group 140 may be located within symbols indexed 1-3. Similarly, the SS in slot 1 of slot group 142 may be located within symbols indexed 1-3 and the SS in slot 1 of slot group 144 may be located within symbols indexed 1-3.

Group 2 may consist of (Xs) consecutive slots and a Group 2 SS may be configured anywhere within the Xs consecutive slots. However, there may be some exceptions such as, but not limited to, type 0 CSS with multiplex pattern 1 and type 0A/2 CSS with a search space ID equal to 0, where the location of the SS within the slot group is based on a particular parameter (e.g., time offset, symbol index, etc.) and/or derived based on a particular equation. An example arrangement of a Group 2 slot group is provided below with regard to FIG. 2.

FIG. 2 shows an example arrangement of Group 1 and Group 2 according to various exemplary embodiments. The example arrangement depicted in FIG. 2 is not intended to limit the exemplary embodiments in any way and is merely provided to demonstrate a general example of how the exemplary MSM framework described above may be utilized.

In this example, Group 1 is configured with a slot group that comprises (Xs=4) slots. Thus, slot group 210 includes slots 211, 212, 213 and 214. Each slot 211-214 may comprise 14 symbols indexed 0-13. Similarly, Group 2 is also configured with a slot group that comprises (Xs=4) slots. Thus, Slot group 250 includes slots 251, 252, 253 and 254. Each slot 251-254 may comprise 14 symbols indexed 0-13. In this example, the arrangement of slots in Group 1 and Group 2 are the same. However, as mentioned above, the exemplary embodiments are not limited to this arrangement and may utilize any appropriate SCS, subframe duration, number of slots per subframe, number of slot groups, slot group size, etc.

In addition, Group 1 is configured with a Group 1 SS within (Ys=2) slots. In this example, the Ys slots include slot 212 and slot 213. Since Ys is greater than 1, the SS 220 in slot 212 and the SS 222 in slot 213 may be located within the first 3 symbols of each slot (e.g., symbols indexed 0-2). Group 2 is configured with SSs in three slots 251-253. Since a Group 2 SS may be located anywhere within a slot group, the SSs 262, 264 and 266 are shown as being located within a different span of symbols for each of the slot groups 251-253. However, the exemplary embodiments are in no way limited to this Group 2 SS set configuration. This is just one possible example of a Group 2 SS set configuration and the exemplary embodiments may apply to any appropriate Group 2 configuration.

### Network Arrangement and Components

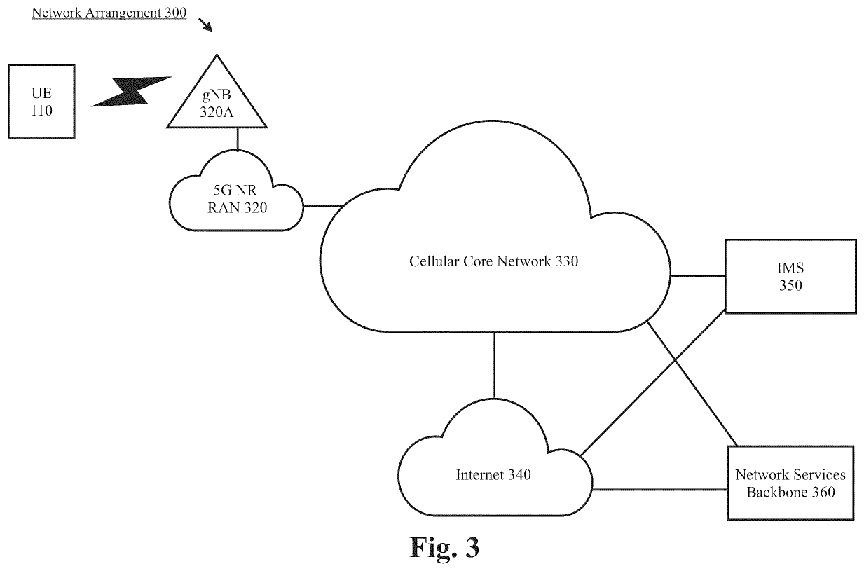

FIG. 3 shows an exemplary network arrangement 300 according to various exemplary embodiments. The exemplary network arrangement 300 includes the UE 110. Those skilled in the art will understand that the UE 110 may be any type of electronic component that is configured to communicate via a network, e.g., mobile phones, tablet computers, desktop computers, smartphones, phablets, embedded devices, wearables, Internet of Things (IoT) devices, etc. It should also be understood that an actual network arrangement may include any number of UEs being used by any number of users. Thus, the example of a single UE 110 is merely provided for illustrative purposes.

The UE 110 may be configured to communicate with one or more networks. In the example of the network arrangement 300, the network with which the UE 110 may wirelessly communicate is a 5G NR radio access network (RAN) 320. However, the UE 110 may also communicate with other types of networks (e.g., 5G cloud RAN, a next generation RAN (NG-RAN), a long-term evolution (LTE) RAN, a legacy cellular network, a wireless local area network (WLAN), etc.) and the UE 110 may also communicate with networks over a wired connection. With regard to the exemplary embodiments, the UE 110 may establish a connection with the 5G NR RAN 320. Therefore, the UE 110 may have a 5G NR chipset to communicate with the 5G NP PAN 320.

The 5G NR RAN 320 may be a portion of a cellular network that may be deployed by a network carrier (e.g., Verizon, AT&T, T-Mobile, etc.). The 5G NR RAN 320 may include, for example, nodes, cells or base stations (e.g., Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set.

Those skilled in the art will understand that any association procedure may be performed for the UE 110 to connect to the 5G NR RAN 320. For example, as discussed above, the 5G NR RAN 320 may be associated with a particular cellular provider where the UE 110 and/or the user thereof has a contract and credential information (e.g., stored on a SIM card). Upon detecting the presence of the 5G NR RAN 320, the UE 110 may transmit the corresponding credential information to associate with the 5G NR PAN 320. More specifically, the UE 110 may associate with a specific base station, e.g., the next generation Node B (gNB) 320A.

The network arrangement 300 also includes a cellular core network 330, the Internet 340, an IP Multimedia Subsystem (IMS) 350, and a network services backbone 360. The cellular core network 330 may refer an interconnected set of components that manages the operation and traffic of the cellular network. It may include the evolved packet core (EPC) and/or the 5G core (5GC). The cellular core network 330 also manages the traffic that flows between the cellular network and the internet 340. The IMS 350 may be generally described as an architecture for delivering multimedia services to the UE 110 using the IP protocol. The IMS 350 may communicate with the cellular core network 330 and the Internet 340 to provide the multimedia services to the UE 110. The network services backbone 360 is in communication either directly or indirectly with the Internet 340 and the cellular core network 330. The network services backbone 360 may be generally described as a set of components (e.g., servers, network storage arrangements, etc.) that implement a suite of services that may be used to extend the functionalities of the UE 110 in communication with the various networks.

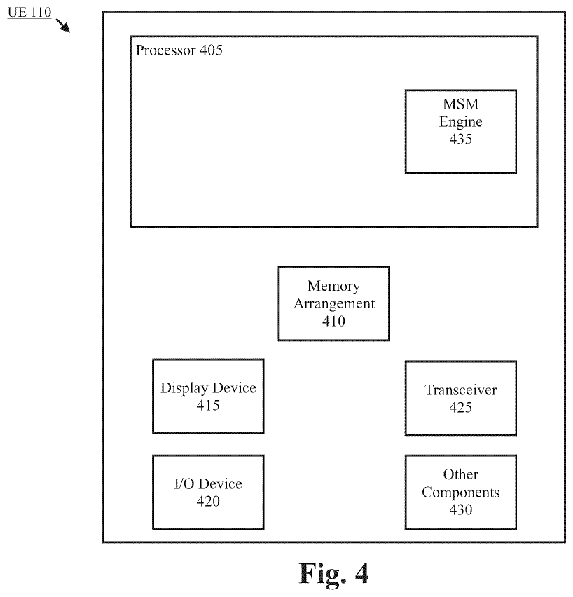

FIG. 4 shows an exemplary UE 110 according to various exemplary embodiments. The UE 110 will be described with regard to the network arrangement 300 of FIG. 3. The UE 110 may include a processor 405, a memory arrangement 410, a display device 415, an input/output (I/O) device 420, a transceiver 425 and other components 430. The other components 430 may include, for example, an audio input device, an audio output device, a power supply, a data acquisition device, ports to electrically connect the UE 110 to other electronic devices, etc.

The processor 405 may be configured to execute a plurality of engines of the UE 110. For example, the engines may include a MSM engine 435. The MSM engine 435 may perform various operations related to MSM including, but not limited to, receiving MSM parameters, identifying a location of one or more Group 1 SSs, identifying a location of one or more Group 2 SSs and monitoring MSM. In addition, the MSM engine 435 may implement the various exemplary techniques introduced herein related to MSM capabilities for multiple cells.

The above referenced engine 435 being an application (e.g., a program) executed by the processor 405 is merely provided for illustrative purposes. The functionality associated with the engine 435 may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 405 is split among two or more processors such as a baseband processor and an applications processor. The exemplary embodiments may be implemented in any of these or other configurations of a UE.

The memory arrangement 410 may be a hardware component configured to store data related to operations performed by the UE 110. The display device 415 may be a hardware component configured to show data to a user while the I/O device 420 may be a hardware component that enables the user to enter inputs. The display device 415 and the I/O device 420 may be separate components or integrated together such as a touchscreen. The transceiver 425 may be a hardware component configured to establish a connection with the 5G NR-RAN 320, an LTE-RAN (not pictured), a legacy RAN (not pictured), a WLAN (not pictured), etc. Accordingly, the transceiver 425 may operate on a variety of different frequencies or channels (e.g., set of consecutive frequencies).

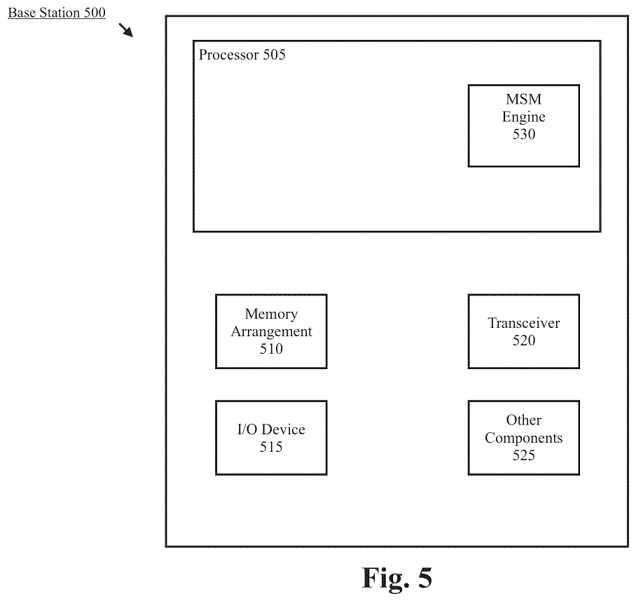

FIG. 5 shows an exemplary base station 500 according to various exemplary embodiments. The base station 500 may represent the gNB 320A or any other access node through which the UE 110 may establish a connection and manage network operations.

The base station 500 may include a processor 505, a memory arrangement 510, an input/output (I/O) device 515, a transceiver 520, and other components 525. The other components 525 may include, for example, an audio input device, an audio output device, a battery, a data acquisition device, ports to electrically connect the base station 500 to other electronic devices, etc.

The processor 505 may be configured to execute a plurality of engines for the base station 500. For example, the engines may include a MSM engine 530. The MSM engine 530 may perform various operations related to the UE 110 performing MSM including, but not limited to, signaling MSM parameters to the UE 110, receiving capability information, configuring CSSs, configuring UE specific SSs, managing a BD/CCE budget and scheduling PDCCH resources for the UE 110.

The above noted engine 530 being an application (e.g., a program) executed by the processor 505 is only exemplary. The functionality associated with the engine 530 may also be represented as a separate incorporated component of the base station 500 or may be a modular component coupled to the base station 500, e.g., an integrated circuit with or without firmware. For example, the integrated circuit may include input circuitry to receive signals and processing circuitry to process the signals and other information. In addition, in some base stations, the functionality described for the processor 505 is split among a plurality of processors (e.g., a baseband processor, an applications processor, etc.). The exemplary embodiments may be implemented in any of these or other configurations of a base station.

The memory 510 may be a hardware component configured to store data related to operations performed by the base station 500. The I/O device 515 may be a hardware component or ports that enable a user to interact with the base station 500. The transceiver 520 may be a hardware component configured to exchange data with the UE 110 and any other UE in the network arrangement 500. The transceiver 520 may operate on a variety of different frequencies or channels (e.g., set of consecutive frequencies). Therefore, the transceiver 520 may include one or more components (e.g., radios) to enable the data exchange with the various networks and UEs.

### MSM Capability for Multiple Cells

When the UE 110 is configured with a number of downlink cells that is greater than a reported number of downlink cells, there is a need to perform a BD/CCE budget calculation to ensure that the derived value remains within the BD/CCE budget. The following approaches may be utilized in this type of scenario. However, it has been identified that these approaches do not consider how to report the capability for Rel-17 MSM and how to calculate the BD/CCE budget for each CC. The exemplary embodiments introduce techniques for reporting this type of capability information and calculating a BD/CCE budget for each CC.

In a first approach, serving cells with a same PDCCH monitoring type including multi-slot based capabilities may be grouped together for further BD/CCE calculations. In some embodiments, within a group of serving cells with multi-slot based capabilities, the serving calls with the same SCS and slot group parameter values (e.g., Xs, Ys) may be grouped together to determine a total BD/CCE budget. In other embodiments, within a group of serving cells with multi-slot based capabilities, the serving cells with the same SCS and slot group parameter values (e.g., Xs, etc.) may be grouped together to determine a total BD/CCE Budget.

In another approach, a serving cell with multi-slot based capabilities may be transformed to an equivalent serving cell with slot based capabilities for further BD/CCE budget calculations. In some embodiments, a serving cell with SCS (U) and multi-slot based capability (e.g., Xs, Ys, etc.) may be considered as an equivalent virtual cell with SCS (U) and slot based capabilities where a slot group for the serving cell is considered as a slot for the virtual cell. In other embodiments, the serving cell with SCS and multi-slot based capability may be considered as an equivalent virtual cell with SCS and slot based capability, where 4/8 slots for the serving cell with SCS is considered as a slot for the virtual cell.

As mentioned above, it has been identified that the above-described approaches do not consider how to report the capability for Rel-17 MSM and how to calculate the BD/CCE budget for each CC. The exemplary embodiments introduce techniques for reporting this type of capability information and calculating a BD/CCE budget for each CC.

FIG. 10 shows a signaling diagram 600 for reporting MSM capability information related to multiple cells according to various exemplary embodiments. The signaling diagram 600 includes the UE 110 and the gNB 320A. The gNB 320A may control one or more serving cells for the UE 110. In some embodiments, the UE 110 may be configured with multiple serving cells. Thus, the example of a single gNB 320A is merely provided for illustrative purposes. The exemplary capability information signaling described herein may occur between the UE 110 and one or more serving cells (e.g., PCell, PSCell, SCell, etc.), base stations or any appropriate type of access node.

In 605, the UE 110 transmits capability information to the gNB 320A. The capability information may relate to MSM for multiple cells, BD/CCE budget calculation or any other appropriate aspect of MSM. Specific examples are provided in detail below.

The capability information in 605 may be provided to the network in one or more messages. In some embodiments, the capability information may be provided in response to a request from the network. In other embodiments, the UE 110 may provide the capability information without an explicit request from the network. However, the exemplary embodiments are not limited to any of the examples provided above. The exemplary embodiments may provide the exemplary capability information introduced herein in any appropriate manner.

In Rel-16, the following capability reporting may be utilized. In one example, the UE 110 may report a capability related to the number of CCs with Rel-15 monitoring capability only. In another example, the UE 110 may report a capability related to the number of CCs with Rel-16 monitoring capability only, e.g., a pdcch-BlindDetectionCA-R16 IE may be provided. In a further example, the UE 110 may report a capability related to the number of CCs with Rel-15 monitoring capability and Rel-16 monitoring capability on different serving cells, e.g., a pdcch-BlindDetectionCA-R15 IE, a pdcch-BlindDetectionCA-R16 IE and a range of a pdcch-BlindDetectionCA-R15 and a pdcch-BlindDetectionCA-R16.

The exemplary embodiments introduce capability information for Rel-17 monitoring capabilities that may not be provided using the Rel-15 and/or Rel-16 messages described above. In one example, a capability related to the number of CCs with Rel-17 monitoring capability only is introduced. In another example, a capability related to a number of CCs with Rel-15 monitoring capability and Rel-17 monitoring capability on different serving cells is introduced. In another example, a capability related to a number of CCs with Rel-16 monitoring capability and Rel-17 monitoring capability on different serving cells is introduced. In a further example, a capability on the number of CCs with Rel-15 monitoring capability, Rel-16 monitoring capability and Rel-17 monitoring capability on different serving cells is introduced.

In one approach, the UE 110 may be configured with a set of minimum values depending on the combination of CCs and their corresponding capabilities (Rel-15, Rel-16 or Rel-17). The capabilities the UE 110 reports should be greater than the minimum values. In one option (option 1), the capability information may indicate any combination of CCs with Rel-15, Rel-16 and Rel-17 monitoring capabilities with a total number of SSs that is less than or equal to 4. In another option (option 2), the capability information may indicate any combination of CCs with Rel-15, Rel-16 and Rel-17 monitoring capabilities with a total number of SS complexity that is less than or equal to 4. However, CCs associated with Rel-16 capabilities are only considered as ½ effective CCs due to BD/CCE limits. The BD/CCE values for a PDCCH monitoring sub-slot in Rel-16 is (2ce) that of PDCCH monitoring slot in Rel-15. The BD/CCE values for a slot group in MSM is the same as that of the PDCCH monitoring slot in Rel-15.

Thus, in Rel-15, a minimum value is 4 Rel-15 SSs equivalent to 4 Rel-15 SSs in complexity. For Rel-15 and Rel-16, the minimum value will be 1 Rel-16 SS (effectively 2 Rel-15 SSs in complexity) and 2 Rel-15 to give a maximum of 4 SS in complexity but 3 actual SSs.

For Rel-17, the minimum value may be 4 Rel-15 SS (effectively 4 Rel-15 SSs in complexity). This may be handled the same way using either option 1 or option 2 described above.

For Rel 15 and Rel-17, the minimum value may be (J) Rel-15 SS (effectively J Rel-15 SSs in complexity) and (K) Rel-17 (where J+K=4) to give a maximum of 4 SS in complexity and 4 actual SSs. This may be handled the same way using either option 1 or option 2 described above.

For Rel-16 and Rel-17, the minimum value may be 1 Rel-16 SS (effectively 2 Rel-15 SSs in complexity) and 2 Rel-17 to give a maximum of 4 SS in complexity but 3 actual SSs. This example relates to option 2. For option 1, F+K may be used instead similar to the example provided above with J+K.

For Rel-15, Rel-16 and Rel-17, the minimum value may be 1 Rel-15 (effectively 1 rel-15 SS in complexity), 1 Rel-16 SS (effectively 2 Rel-15 SSs in complexity) and 1 Rel-17 (effectively 1 rel-15 SS in complexity), to give a maximum of 4 SS in complexity but 3 actual SSs. This example relates to option 2. For option 1, J+F+K=4 may be used even though SS complexity would be over 4.

Throughout this description, the IE for the capability related to the number of CCs with Rel-17 monitoring capability only may be referred to as “pdcch-BlindDetectionCA-R17.” However, reference to pdcch-BlindDetectionCA-R17 is provided as an example, different entities may refer to similar concepts by a different name. The value of pdcch-BlindDetectionCA-R17 may be equal to 4.

Reporting a capability for the number of CCs with Rel-15 monitoring capability and Rel-17 monitoring capability on different serving cells may include providing a pdcch-BlindDetectionCA-R15 for Rel-15 PDCCH monitoring capabilities and a pdcch-BlindDetectionCA-R17 for Rel-17 PDCCH monitoring capabilities. In some examples, a range of pdcch-BlindDetectionCA-R17 and pdcch-BlindDetectionCA-RIS may be provided where the minimum of pdcch-BlindDetectionCA-R15 plus pdcch-BlindDetectionCA-R17 is equal to 4.

Reporting a capability for the number of CCs with Rel-16 monitoring capability and Rel-17 monitoring capability on different serving cells may include providing a pdcch-BlindDetectionCA-R16 for Rel-16 PDCCH monitoring capabilities and a pdcch-BlindDetectionCA-R17 for Rel-17 PDCCH monitoring capabilities. In some examples, a range of pdcch-BlindDetectionCA-R17 and pdcch-BlindDetectionCA-R16 may be provided where the minimum of pdcch-BlindDetectionCA-R16 plus pdcch-BlindDetectionCA-R17 is equal to 3.

Reporting a capability for the number of CCs with Rel-15 monitoring capability, Rel-16 monitoring capability and Rel-17 monitoring capability on different serving cells may include providing a pdcch-BlindDetectionCA-R15 for Rel-15 PDCCH monitoring capabilities, a pdcch-BlindDetectionCA-R16 for Rel-16 PDCCH monitoring capabilities and a pdcch-BlindDetectionCA-R17 for Rel-17 PDCCH monitoring capabilities. In some examples, a range of pdcch-BlindDetectionCA-R17, pdcch-BlindDetectionCA-R15 and pdcch-BlindDetectionCA-R16 monitoring capabilities may be provided where the minimum of pdcch-BlindDetectionCA-R15 plus pdcch-BlindDetectionCA-R16 and pdcch-BlindDetectionCA-R17 is equal to 4.

For reporting Rel-15 monitoring capabilities, Rel-16 monitoring capabilities and Rel-17 monitoring capability on different serving cells or any combination of two or more capabilities comprising at least a Rel-17 monitoring capability, the UE 110 may report a combination of pdcch-BlindDetectionCA-R17 and one or more of pdcch-BlindDetectionCA-R16 and pdcch-BlindDetectionCA-R15 as a UE capability.

In this example, the UE 110 reports more than one combination of pdcch-BlindDetectionCA-R17 and pdcch-BlindDetectionCA-R16 and/or pdcch-BlindDetectionCA-R15. In 610, the gNB 320A, determines a combination for the UE 110 to use for scaling PDCCH monitoring capability when the number of CCs configured is larger than the reported capability. In 615, the gNB 320A transmits a signal to the UE 110 with the configured combination.

To provide an example, assume the UE 110 indicates a combination of (Rel-15, Rel-16, Rel-17)=(3, 3, 3) and (4, 2, 4). If the gNB 320A configures the UE 110 with 5 Rel-15 CCs, 5 Rel-16 CCs and 5 Rel-17 CCs, the gNB 320A may also signal to the UE 110 which of the UE capabilities it is expecting the UE 110 to use (e.g. (3, 3, 3) or (4, 2, 4)). For each set of CCs with the same configuration (Rel-15/Rel-16/Rel-17), both the gNB 320A and the UE 110 may distribute (or scale) the maximum BD/CCE limits across the 5 configured CCs assuming that the UE 110 can only manage a maximum of 3 CCs for the specific CC group. The scaling within the Rel-15 and Rel-16 groups occurs based on existing 3GPP Specification. Within the group of serving cells with multi-slot-based capability (Rel-17 group), the serving cells with the same SCS and Xs value are grouped together to follow a total BD/CCE budget based on the signaled configuration (5 CCs) and UE capability (3 CCs). The total budget across all 5 CCs will be equal to 3 multiplied by the limits per CC. The budget for a specific (SCS, Xs) will be the total budget scaled by the ratio of the number of CCs configured for that specific (SCS, Xs) and the total number of CCs configured (5).

In addition, the exemplary embodiments introduce techniques related to alignment for MSM across multiple cells. In one example, slot boundaries are aligned across multiple serving cells. In another example, if grouping Xs slots only, the slot boundaries of multiple serving cells are aligned, and the boundary of the Ys slots are aligned across the serving cells. In further examples, the slot boundaries of multiple serving cells are aligned, the boundary of Ys slots are aligned across serving cells and when Ys=1, the SS FG arrangement (e.g., W, Z) within each Ys may be aligned across serving cells.

The UE 110 may report its alignment capability related to MSM across multiple serving cells. In one example, the UE 110 may only be capable of MSM across multiple serving cells if the slot boundaries are aligned. In another example, the UE 110 may only be capable of MSM across multiple serving cells if the slot boundaries are aligned and the Ys slots are aligned. In a further example, the UE 110 may only be capable of MSM across multiple serving cells if the slot boundaries are aligned, the Ys slots are aligned and the SS FG arrangement (e.g., W, Z) within each Ys may be aligned. In another example, the UE 110 may process both aligned and unaligned slot boundaries, Ys slots, SSs, etc. The UE 110 may report its corresponding capability information and perform PDCCH monitoring in accordance with its reported capability information.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. The exemplary embodiments of the above described methods may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

1. An apparatus comprising processing circuitry configured to:
generate, for transmission to a base station, capability information corresponding to a release 17 (Rel-17) multi-slot physical downlink control channel (PDCCH) monitoring (MSM) capability; and
process, based on signaling received from the base station, configuration information to perform MSM, wherein the a number of configured downlink cells is a greater than a reported number of downlink cells.

2. The apparatus of claim 1, wherein the capability information is related to a number of component carriers (CCs) with Rel-17 MSM capability.

3. The apparatus of claim 1, wherein the capability information is related to a number of component carriers (CCs) with Rel-17 MSM capability and a number of CCs with release 15 (Rel-15) MSM capability on different serving cells.

4. The apparatus of claim 1, wherein the capability information is related to a number of component carriers (CCs) with Rel-17 MSM capability and a number of CCs with release 16 (Rel-16) MSM capability on different serving cells.

5. The apparatus of claim 1, wherein the capability information is related to a number of component carriers (CCs) with Rel-17 MSM capability, a number of CCs with release 16 (Rel-16) MSM capability and a number of CCs with release 15 (Rel-15) MSM capability on different serving cells.

6. An apparatus comprising processing circuitry configured to:
process, based on signaling received from a user equipment (UE), capability information corresponding to a release 17 (Rel-17) multi-slot physical downlink control channel (PDCCH) monitoring (MSM) capability; and
generate, for transmission to the UE, configuration information related to MSM, wherein the UE is configured with a number of downlink cells that are greater than a reported number of downlink cells.

7. The apparatus of claim 6, wherein the processing circuitry is further configured to:
derive a blind detection (BD)/control channel element (CCE) budget for one or more component carriers (CCs) based on the capability information.

8. The apparatus of claim 6, wherein the capability information is related to a number of component carriers (CCs) with Rel-17 MSM capability.

9. The apparatus of claim 6, wherein the capability information is related to a number of component carriers (CCs) with Rel-17 MSM capability and a number of CCs with release 15 (Rel-15) MSM capability on different serving cells.

10. The apparatus of claim 6, wherein the capability information is related to a number of component carriers (CCs) with Rel-17 MSM capability and a number of CCs with release 16 (Rel-16) MSM capability on different serving cells.

11. The apparatus of claim 6, wherein the capability information is related to a number of component carriers (CCs) with Rel-17 MSM capability, a number of CCs with release 16 (Rel-16) MSM capability and a number of CCs with release 15 (Rel-15) MSM capability on different serving cells.

12. A user equipment (UE), comprising:
a transceiver configured to communicate with a network; and
a processor communicatively coupled to the transceiver and configured to:
generate, for transmission to a base station, capability information corresponding to a release 17 (Rel-17) multi-slot physical downlink control channel (PDCCH) monitoring (MSM) capability; and
process, based on signaling received from the base station, configuration information to perform MSM, wherein the UE is configured with a number of downlink cells that are greater than a reported number of downlink cells.

13. The UE of claim 12, wherein the capability information is related to a number of component carriers (CCs) with Rel-17 MSM capability.

14. The UE of claim 12, wherein the capability information is related to a number of component carriers (CCs) with Rel-17 MSM capability and a number of CCs with release 15 (Rel-15) MSM capability on different serving cells.

15. The UE of claim 12, wherein the capability information is related to a number of component carriers (CCs) with Rel-17 MSM capability and a number of CCs with release 16 (Rel-16) MSM capability on different serving cells.

16. The UE of claim 12, wherein the capability information is related to a number of component carriers (CCs) with Rel-17 MSM capability, a number of CCs with release 16 (Rel-16) MSM capability and a number of CCs with release 15 (Rel-15) MSM capability on different serving cells.

17-22. (canceled)
